(19) United States
(12) Patent Application Publication
(10) Pub. No.: US 2025/0036829 A1
(43) Pub. Date: Jan. 30, 2025

(54) CAD MODEL ANALYSIS METHOD AND APPARATUS, DEVICE AND STORAGE MEDIUM

(71) Applicant: Beihang University, Beijing (CN)

(72) Inventors: Bin ZHOU, Beijing (CN); Shengdi ZHOU, Beijing (CN); Li CUI, Beijing (CN); Qinping ZHAO, Beijing (CN)

(73) Assignee: Beihang University, Beijing (CN)

(21) Appl. No.: 18/783,430

(22) Filed: Jul. 25, 2024

(30) Foreign Application Priority Data
Jul. 25, 2023 (CN) 202310920244.0

(51) Int. Cl. G06F 30/20; G06F 30/10

(52) U.S. Cl. CPC G06F 30/20; G06F 30/10

(57) ABSTRACT

The present application provides a CAD model analysis method and apparatus, a device and a storage medium, which relates to the technical field of industrial manufacturing. The CAD model based on a BRep representation is transformed into a graph structure. The graph structure is input into an analytical model to obtain a modeling sequence of the CAD model. By transforming the CAD model with a BRep representation into the graph structure, the analytical model learns the modeling feature in the graph structure, and the modeling feature type and the feature parameter are obtained, so as to enable the prediction of the model building process of the CAD model and facilitate to subsequently make parametric re-editing of the CAD model

### CROSS REFERENCE OF RELATED APPLICATIONS

The present application claims priority to Chinese Patent Application No. 202310920244.0, filed to China National Intellectual Property Administration on Jul. 25, 2023 and titled “CAD model analysis method and apparatus, device and storage medium”, the entire content of which is incorporated herein by reference.

### TECHNICAL FIELD

The present application relates to the technical field of industrial manufacturing, in particular to a CAD model analysis method and apparatus, a device and a storage medium.

### BACKGROUND

The computer aided design (CAD) model plays an indispensable role in the field of industrial manufacturing. At present, most industrial parts are designed by a CAD software, and then a parameterized CAD model is derived, and analysis and manufacturing are subsequently carried out based on the parameterized CAD model. A complete CAD model should include a geometric structure and a model building process of a model. However, at present, a CAD model transmitted or delivered on the Internet is generally in Boundary Representation (BRep), where a geometric structure and topological information of a CAD model is described by the BRep representation, and the original model building process is lost, that is, historical information for building a CAD model is lost. Practice has proved that the model building process is of great significance and value in an industrial design, scientific computing modeling, reverse engineering and so on. Therefore, it is of great research value to predict the model building process of the CAD model.

In the related arts, Fusion360Gym can be adopted for predicting a model building process of a CAD model with the BRep representation. Specifically, according to a topological structure of the CAD model described by the BRep representation, the CAD model is represented as a graph structure, where a node of the graph structure is a bounded face of the CAD model, and an edge of the graph structure describes whether there is a connection between the faces of the CAD model, and the graph structure is put into the Fusion360Gym framework as a target geometric state; then, starting from a whiteboard, a current geometric state and the target geometric state are given to an agent, and the agent predicts the next operation through the Multi-Layer Perceptron (MLP), so as to update the current geometric state. By comparing the geometric differences between the current geometric state and the target geometric state again, it can be a feedback of the agent's prediction, so as to decide whether the agent's prediction for this step is adopted or not. According to the above process, when the current geometric state is consistent with the target geometric state or a maximum upper limit of steps is reached, the deducing process stops and the corresponding model building process is obtained.

However, in order to reduce the difficulty of training, the above-mentioned model building process adopts an extrusion based on an existing face, so it is still difficult to make parametric editing on the obtained model building process.

### SUMMARY

The present application provides a CAD model analysis method and apparatus, a device and a storage medium, which are configured for solving the problem that it is difficult to make parametric editing on a model building process.

In a first aspect, the present application provides a CAD model analysis method that includes:
acquiring a CAD model based on a BRep representation;
transforming the CAD model into a graph structure, where a node of the graph structure contains a bounded face, an edge and a coedge, and the edge of the graph structure represents a connection relationship between the nodes in the graph structure, and the connection relationship is determined according to a topological structure of the CAD model and directionality of the graph structure;
inputting the graph structure into an analytical model to obtain a modeling sequence of the CAD model output by the analytical model, where the modeling sequence represents a feature modeling-based model building process, and the modeling sequence contains a modeling feature type and a feature parameter corresponding to the modeling feature type. The analytical model includes an encoder and a decoder, and the encoder includes a feature extraction module and a pooling module, and the feature extraction module is configured for extracting a local feature of the node in the graph structure, and the pooling module is configured for performing a pooling operation on the local feature to output a global feature; the decoder includes a feature fusion module, an inter-attention module and a prediction module, and the feature fusion module is configured for fusing the global feature and a dynamic modeling sequence to output a first fused feature, and the inter-attention module is configured for fusing the first fused feature and the local feature to output a second fused feature, and the prediction module is configured for outputting the modeling sequence according to the second fused feature, and the dynamic modeling sequence is a dynamic output of the decoder.

In a possible implementation, the modeling sequence in the CAD model analysis method includes at least one modeling command, where the modeling command contains a modeling feature type and a feature parameter corresponding to the modeling feature type, and the modeling sequence is obtained by stacking feature parameters corresponding to different modeling feature types in the at least one modeling command, where a useless feature parameter in the modeling command is set with a useless identifier.

In a possible implementation, the feature fusion module in the CAD model analysis method is specifically configured for performing embedding for the modeling feature type, the feature parameter and a modeling command position in the dynamic modeling sequence to obtain an intermediate feature sequence; fusing the global feature and the intermediate feature sequence to output the first fused feature.

In a possible implementation, the analytical model in the CAD model analysis method can be trained by the followings: acquiring a CAD model data set, where the CAD model data set includes a sample CAD model and a parametric modeling sequence corresponding to the sample CAD model, and the parametric modeling sequence is obtained by parameterizing a modeling sequence corresponding to the sample CAD model, and the parametric modeling sequence records a modeling feature type of the sample CAD model and a feature parameter corresponding to the modeling feature type according to an order of building the sample CAD model; transforming the sample CAD model into a graph structure; training the analytical model according to a graph structure corresponding to the sample CAD model and the parametric modeling sequence to obtain a prediction modeling sequence corresponding to the sample CAD model; determining a loss value of the prediction modeling sequence relative to the parametric modeling sequence based on a cross entropy loss function; adjusting a model parameter of the analytical model according to the loss value.

In a possible implementation, the CAD model analysis method further includes: adopting a joint probability distribution function of a maximized feature type and a maximized feature parameter to maximize the probability of the prediction modeling sequence, where the joint probability distribution function satisfies the following formula:

$$p ( S ; θ ) = {\prod }_{i = 1}^{N} p ( {t}_{i} , {p}_{i} \vert {t}_{< i} , {p}_{< i} , z ; θ )$$

Where p(S; θ) represents the joint probability distribution function of a maximized feature type and a maximized feature parameter, S represents the prediction modeling sequence, θ represents the model parameter of the analytical model, N represents a length of dynamic modeling sequence, z represents a modeling feature of the CAD model, t represents a modeling feature type, p represents a feature parameter, tᵢ and pᵢ respectively represents a modeling feature type and a feature parameter output by the analytical model at the time i, and t_{<i} and p_{<i} respectively represents a modeling feature type and a feature parameter output by the analytical model at the time i−1.

In a possible implementation, the CAD model data set in the CAD model analysis method is obtained by: acquiring an initial data set, where the initial data set contains a sample CAD model and a parametric modeling sequence corresponding to the sample CAD model, and the sample CAD model contains a plurality of basic modeling features; performing data enlargement to the initial data set by a given data enhancement mode to obtain the CAD model data set, where the data enhancement mode is to represent a model building process of the sample CAD model as a modeling sequence and then make an adjustment to the modeling sequence in a back-to-front manner, and the adjustment includes random deletion and/or random modification.

In a possible implementation, the sample CAD model in the CAD model analysis method has geometric validity.

In a second aspect, the present application provides a CAD model analysis apparatus that includes:
an acquisition module configured for acquiring a CAD model based on a BRep representation;
a transformation module configured for transforming the CAD model into a graph structure, where a node of the graph structure contains a bounded face, an edge and a coedge, and the edge of the graph structure represents a connection relationship between the nodes in the graph structure, and the connection relationship is determined according to a topological structure of the CAD model and directionality of the graph structure;
an analytical module configured for inputting the graph structure into an analytical model to obtain a modeling sequence of the CAD model output by the analytical model, where the modeling sequence represents a feature modeling-based model building process, and the modeling sequence contains a modeling feature type and a feature parameter corresponding to the modeling feature type. The analytical model includes an encoder and a decoder, and the encoder includes a feature extraction module and a pooling module, and the feature extraction module is configured for extracting a local feature of the node in the graph structure, and the pooling module is configured for performing a pooling operation on the local feature to output a global feature; the decoder includes a feature fusion module, an inter-attention module and a prediction module, and the feature fusion module is configured for fusing the global feature and a dynamic modeling sequence to output a first fused feature, and the inter-attention module is configured for fusing the first fused feature and the local feature to output a second fused feature, and the prediction module is configured for outputting the modeling sequence according to the second fused feature, and the dynamic modeling sequence is a dynamic output of the decoder.

In a possible implementation, the analytical module can be specifically configured for obtaining a modeling sequence, and the obtained modeling sequence contains at least one in modeling command that contains a modeling feature type and a feature parameter corresponding to the modeling feature type, and the modeling sequence is obtained by stacking feature parameters corresponding to different modeling feature types in the at least one modeling command, where a useless feature parameter in the modeling command is set with a useless identifier.

In a possible implementation, the feature fusion module in the CAD model analysis apparatus can be specifically configured for: performing embedding for the modeling feature types, the feature parameters and a modeling command position in the dynamic modeling sequence to obtain an intermediate feature sequence; fusing the global feature and the intermediate feature sequence to output the first fused feature.

In a possible implementation, the analytical model in the CAD model analysis apparatus can be trained by the followings: an acquisition module can be specifically configured for acquiring a CAD model data set, where the CAD model data set includes a sample CAD model and a parametric modeling sequence corresponding to the sample CAD model, and the parametric modeling sequence is obtained by parameterizing a modeling sequence corresponding to the sample CAD model, and the parametric modeling sequence records a modeling feature type of the sample CAD model and a feature parameter corresponding to the modeling feature type according to an order of building the sample CAD model; correspondingly, the transformation module can be specifically configured for transforming the sample CAD model into the graph structure; the analytical module can also be configured for training the analytical model according to the graph structure corresponding to the sample CAD model and the parametric modeling sequence and obtaining a prediction modeling sequence corresponding to the sample CAD model. Correspondingly, the CAD model analysis apparatus can also include a determining module and an adjusting module, where the determining module can be specifically configured for determining a loss value of the prediction modeling sequence relative to the parametric modeling sequence based on a cross entropy loss function; and the adjustment module can be specifically configured for adjusting a model parameter of the analytical model according to the loss value.

In a possible implementation, the CAD model analysis apparatus may further include a maximization module that may be specifically configured for: adopting a joint probability distribution function of a maximized feature type and a maximized feature parameter to maximize the probability of the prediction modeling sequence, where the joint probability distribution function satisfies the following formula:

$$p ( S ; θ ) = {\prod }_{i = 1}^{N} p ( {t}_{i} , {p}_{i} \vert {t}_{< i} , {p}_{< i} , z ; θ )$$

Where p(S; θ) represents the joint probability distribution function of a maximized feature type and a maximized feature parameter, S represents the prediction modeling sequence, θ represents the model parameter of the analytical model, N represents a length of dynamic modeling sequence, z represents a modeling feature of the CAD model, t represents a modeling feature type, p represents a feature parameter, tᵢ and pᵢ respectively represents a modeling feature type and a feature parameter output by the analytical model at the time i, and t_{<i} and p_{<i} respectively represents a modeling feature type and a feature parameter output by the analytical model at the time i−1.

In a possible implementation, the CAD model data set in the CAD model analysis apparatus is obtained by the followings: the acquisition module can be configured for acquiring a CAD model data set that includes a sample CAD model and a parametric modeling sequence corresponding to the sample CAD model, and the sample CAD model contains a plurality of basic modeling features; correspondingly, the CAD model analysis apparatus can also include a data enlargement module that can be specifically configured for performing data enlargement to the initial data set through a given data enhancement mode as to obtain a CAD model data set, where the data enhancement mode is to represent the model building process of the sample CAD model as a modeling sequence and then make an adjustment to the modeling sequence in a back-to-front manner, and the adjustment includes random deletion and/or random modification.

In a possible implementation, the sample CAD model in the CAD model analysis apparatus has geometric validity.

In a third aspect, the present application provides an electronic device that includes a memory and a processor. The memory is configured for storing a program instruction; and the processor is configured for calling the program instruction in the memory to execute the CAD model analysis method of the first aspect.

In a fourth aspect, the present application provides a computer-readable storage medium, where the computer-readable storage medium stores a computer-executable instruction that, when executed, enables to implement the CAD model analysis method of the first aspect.

In a fifth aspect, the present application provides a computer program product that contains a computer program, and the computer program, when executed by a processor, is configured for implementing the CAD model analysis method of the first aspect.

According to the CAD model analysis method and apparatus, the device and the storage medium provided by the present application, a connection relationship between nodes in the graph structure can be obtained by transforming a CAD model with a BRep representation into a graph structure, and a modeling sequence is obtained by an analytical model learning a modeling feature in the graph structure according to the connection relationship, where the modeling sequence includes a modeling feature type and a feature parameter, so as to achieve that a feature modeling-based model building process for building the CAD model is deduced based on the CAD model based on a given BRep representation, and facilitate subsequent parametric re-editing of the CAD model.

### BRIEF DESCRIPTION OF DRAWINGS

The accompanying drawings, which are incorporated in and constitute a part of this specification, illustrate embodiments consistent with the present application and together with the description, serve to explain the principle of the present application.

FIG. 1 is a schematic diagram of a network architecture of Fusion360Gym provided by an embodiment of the present application.

FIG. 2 is a comparative schematic diagram of the sketch extrusion and the face extrusion provided by an embodiment of the present application.

FIG. 3 is a schematic diagram of an application scenario provided by an embodiment of the present application.

FIG. 4 is a schematic flowchart of a CAD model analysis method provided by an embodiment of the present application.

FIG. 5 is a schematic diagram of a network architecture of an analytical model provided by an embodiment of the present application.

FIG. 6 is a schematic diagram of a zonegraph method provided by an embodiment of the present application.

FIG. 7 is a schematic diagram of some sample CAD models provided by an embodiment of the present application.

FIG. 8 is a schematic diagram of a qualitative comparison result provided by an embodiment of the present application.

FIG. 9 is a schematic structural diagram of a CAD model analysis apparatus provided by an embodiment of the present application.

FIG. 10 is a schematic structural diagram of an electronic device provided by an embodiment of the present application.

Through the above drawings, a clear embodiment of the present application has been shown, which will be described in more detail later. These drawings and the description are not intended to limit the scope of the concept of the present application in any way, but to explain the concept of the present application to those skilled in the art by referring to a specific embodiment.

### DESCRIPTION OF EMBODIMENTS

Description will now be made in detail to exemplary embodiments, examples of which are illustrated in the accompanying drawings. When the following description refers to the accompanying drawings, the same number in different accompanying drawings indicate the same or similar element, unless otherwise indicated. Implementations described in the following exemplary embodiments do not represent all implementations consistent with the present application. Rather, they are merely examples of the apparatus and the method consistent with some aspects of the present application as detailed in the appended claims.

The terms “first” and “second” in the specification and claims of the present application are used to distinguish similar objects, and are not necessarily used to describe a specific order or sequence. It should be understood that the data in such usage can be interchanged under appropriate circumstances, so that the embodiments of the present application described herein can be implemented in other orders than those illustrated or described herein, for example. Furthermore, the terms “include” and “have” and any variations thereof are intended to cover non-exclusive inclusion. For example, a process, system, product or device that includes a series of steps or units need not be limited to those explicitly listed, but may include other steps or units not explicitly listed or inherent to the process, system, product or device.

In practical applications, due to the lack of the model building process in the CAD model, unnecessary labor costs are added to the subsequent model re-editing, understanding the designer's modeling intention and subsequent computer aided engineering (CAE) model analysis.

In the related art, for the CAD model with a BRep representation, a common method is to transform the BRep representation into a construct solid geometry (CSG) representation to describe the model building process (or a modeling process) of the CAD model. The construct solid geometry is to describe the model building process of the CAD model in the form of binary tree, where a leaf node is a predefined basic graphic unit (which can be abbreviated as a primitive), such as a cylinder, a sphere, a cube, etc.; where a middle node represents a Boolean operation, that is, the Boolean operation is performed on the leaf node, and the geometric shape of a middle state is generated from top to bottom, and finally the desired geometric model is generated as a root node. However, due to the limited predefined geometry, the representation ability of CSG is limited, especially for a high-order curve, which is difficult to describe.

In addition, a CSG tree is built in the form of semi-space segmentation, that is, the leaf node represents a segmentation face of the segmentation space, which is an implicit representation, which leads to the non-intuitive and high complexity in model editing.

At present, when creating a three-dimensional model, most CAD software creates it in the way of feature modeling. The general process is as follows: (1) selecting a plane; (2) drawing a two-dimensional sketch through a point and a line, which is called a sketch feature; (3) generating a corresponding three-dimensional model by extruding the two-dimensional sketch along a certain direction through an extrusion feature, or generate a three-dimensional model by rotating the sketch around a specified axis, which is called a rotation feature. According to the above procedures sequentially, new modelling drawing can be performed on the existing three-dimensional model, and a new three-dimensional model is generated, which is called feature modeling.

Therefore, in addition to the CSG representation, the feature modeling can also be configured for predicting the model building process to obtain a modeling result of a CAD model.

Compared with CSG representation, the feature-based modeling has stronger representation ability and more intuitive editing methods for users. However, at present, there are few related works based on the feature modeling, and it is still difficult to make the parametric editing.

In order to solve the above problem, the present application proposes a CAD model analysis method. For a CAD model with a BRep representation, this method adopts a graph structure transformation and an analytical model to deduce the feature modeling-based model building process for building the CAD model and predict a modeling feature type and a feature parameter corresponding to the modeling feature type, and parametric re-editing can be achieved. The analytical model is a kind of deep learning network framework, which uses attention mechanism and the like to fuse the features of the CAD model, so that the analytical model can better learn the modeling feature of the CAD model.

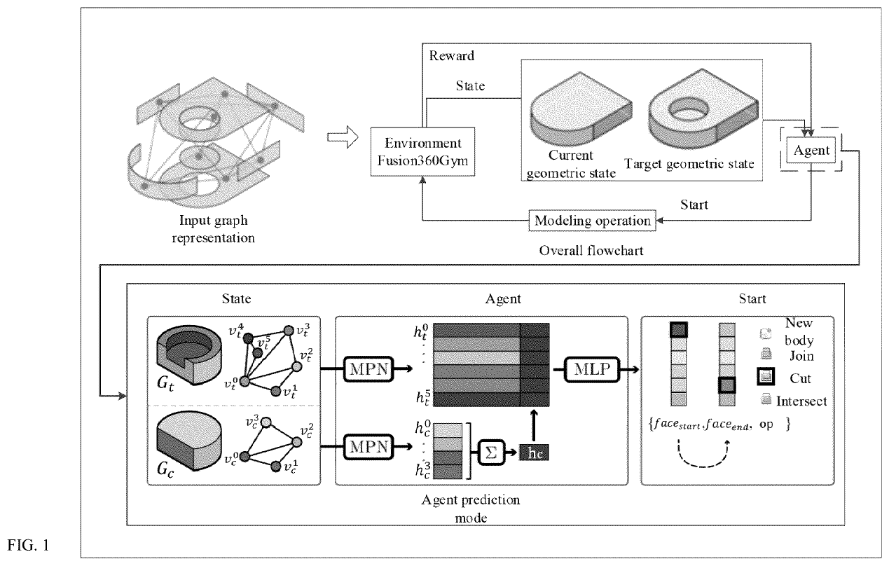

In some examples, a Fusion360Gym method is used for the model building process of a three-dimensional CAD model based on a BRep representation, that is, the three-dimensional CAD model is input and the corresponding model building process based on an extrusion feature is output. The specific operation is shown in FIG. 1.

As shown in FIG. 1, a CAD model is provided, and is input into the Fusion360Gym environment, and a current geometric state G_{c} and a target geometric state Gₜ are obtained, where the current geometric state G_{c} contains vertexes v_{c}⁰, v_{c}¹, v_{c}² and v_{c}³, and the target geometric state Gₜ contains vertexes vₜ⁰, vₜ¹, vₜ², vₜ³, vₜ⁴ and vₜ⁵ In a subsequent decision-making scenario, the Fusion360Gym environment interacts with an agent, and the agent uses the message passing networks (MPN) to predict the next model building action, the action can be output in the form of a modeling operation, and the modeling operation of the current geometric state, such as a sketch extrusion operation and a face extrusion operation, are allowed to be modified by the agent. In addition, the relevant personnel can define a customized reward function according to the task. For example, if the current geometric state matches the target geometric state completely, the agent may obtain a reward of 1, and if the matching degree is 80%, it will obtain a reward of 0.8, and if the matching degree is 50%, it will obtain a reward of 0.5, etc.

For example, a pair of geometric graphs are adopted as the state (G_{c}, Gₜ), and the corresponding face extrusion action a={faceₛₜₐᵣₜ, face_{end}, op} is output, where G_{c} and Gₜ can be given by using a face-adjacency graph, and the vertexes v_{c}⁰, v_{c}¹, v_{c}² and v_{c}³ of the graph represent faces of the current geometric state G_{c}, and the vertexes vₜ⁰, vₜ¹, vₜ², vₜ³, vₜ⁴ and vₜ⁵ of the graph represent faces of the target geometric state Gi, and a vertex feature can be calculated from each face. The calculated vertex feature is respectively input into two independent MPNs for coding, and the MPNs can aggregate messages along the edge of the graph. Specifically, the first MPN branch of the agent part generates a set of node embedding vectors hₜ⁰, . . . , hₜ⁵, and the second MPN branch of the agent part generates a set of node embedding vectors h_{c}⁰, . . . , h_{c}³, which node embedding vectors are added to generate a hidden vector h_{c} of the current geometric state. A cascade vector is generated by cascading the vectors hₜ⁰, . . . , hₜ⁵, and the next model building action is predicted with the MLP. In an implementation, an end face can be predicted based on a predicted start face.

In addition, the face start and face end in the face extrusion action a={faceₛₜₐᵣₜ, face_{end}, op} are the start face and the end face, which are parallel faces referenced from the target geometric state, and op represents an operation type, including new body, join, cut and intersect.

The start face can define an extrusion profile, and the end face can define a distance to be extruded, and it does not need to match the shape of the start face. A target constraint reconstruction using the face extrusion has the advantage of narrowing the scope of prediction problems through a shorter modeling sequence and a simpler action.

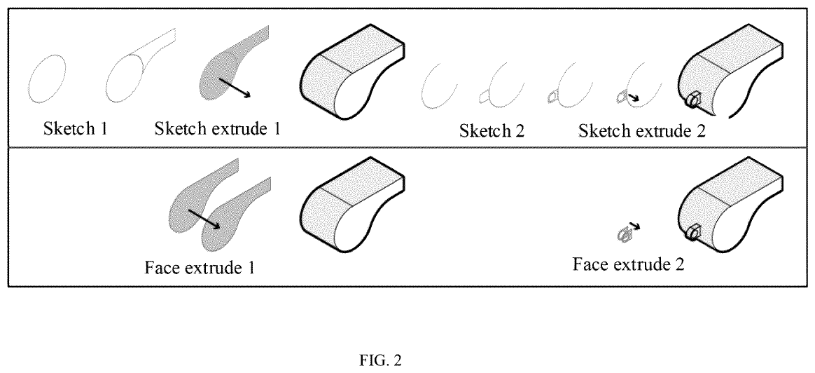

Compared with the conventional sketch extrusion method, the Fusion360Gym method adopts an extrusion operation based on an existing face instead of an extrusion operation based on the parametric sketch in order to simplify the training difficulty. The difference between the two methods is shown in FIG. 2. As can be seen in FIG. 2, a sketch-based extrusion needs to draw a two-dimensional sketch first, while a face-based extrusion is to search an existing face from the CAD model itself and extrude based on the existing face.

In practical application, the Fusion360Gym method mainly focuses on an extrusion feature, and the extrusion feature is determined by the parallelism of faces in the CAD model. Therefore, such strong priori makes the method have high accuracy in determining the extrusion feature, but it also limits the expansibility of the CAD model. In addition, in order to reduce the training difficulty, this method adopts an extrusion operation based on an existing face, that is, the corresponding sketch feature is not recognized, and therefore the generated modeling sequence cannot be used for the parametric editing of a two-dimensional sketch of the CAD model. This method needs to be trained and applied by a software (such as the Fusion360 software), and the corresponding software needs to be installed, and it takes a long time to deduce a large number of CAD models, which easily leads to a machine collapse.

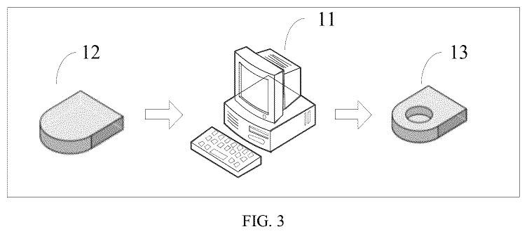

FIG. 3 is a schematic diagram of an application scenario provided by an embodiment of the present application. As shown in FIG. 3, the present application scenario includes an intelligent device 11, a current geometric state 12 of a CAD model and a desired target geometric state 13 of the CAD model, so as to enable model re-editing of the CAD model. In practical application, a plurality of different CAD models can be input into the intelligent device 11 at the same time, and the CAD models can be analyzed by a program related to the analytical model stored in the intelligent device 11 to obtain a modeling feature type and a feature parameter corresponding to the modeling feature type, so as to perform parametric re-editing on the current geometric state of the CAD model, and then obtain the target geometric state of the CAD model.

It should be noted that the intelligent device 11 can also be replaced by a server cluster or other computing device with certain computing power, such as a computer, a notebook or a personal digital assistant (PDA), etc.

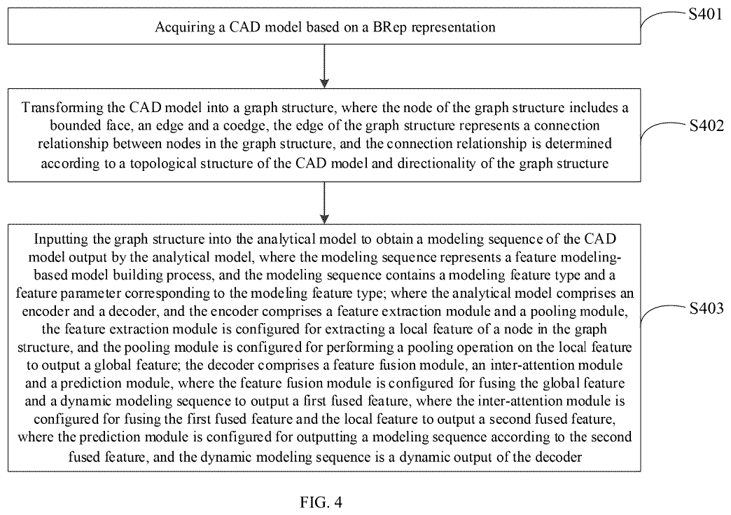

A CAD model analysis method according to an exemplary implementation of the present application is described below with reference to FIG. 4 in combination with the present application scenario of FIG. 3. It should be noted that the above application scenario is only shown for the convenience of understanding the spirit and principle of the present application, and the implementation of the present application is not limited by the present application scenario shown in FIG. 3.

FIG. 4 is a schematic flowchart of a CAD model analysis method provided by an embodiment of the present application. As shown in FIG. 4, the CAD model analysis method in the embodiment of the present application includes the following steps.
S401: acquiring a CAD model based on a BRep representation.

At present, the BRep representation has been used as a representation standard of a CAD model (or a three-dimensional model, a three-dimensional CAD model), which supports the data flow between different CAD software. However, since the BRep only records the complete geometric information (or a geometric structure and a geometric model) and the historical information of building the geometric model is lost, in some studies, the CAD model based on the BRep representation can be analyzed, that is, the historical information of building the geometric model can be predicted from the geometric information of the BRep representation.
S402: transforming the CAD model into a graph structure, where the node of the graph structure includes a bounded face, an edge and a coedge, the edge of the graph structure represents a connection relationship between nodes in the graph structure, and the connection relationship is determined according to a topological structure of the CAD model and directionality of the graph structure.

The graph structure is a form to describe the CAD model, that is, through infinitely extending the bounded face of the CAD model, the bounded faces can be enclosed into closed graphs in space, and the graph structure is formed by connecting the closed graphs in the space.

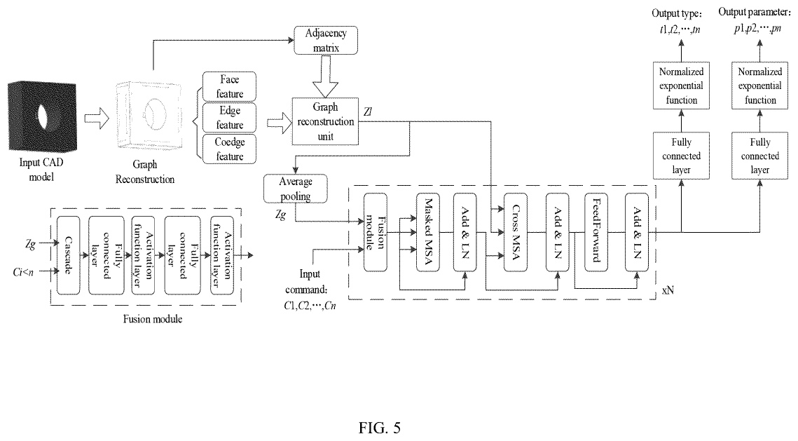

FIG. 5 is a schematic diagram of a network architecture of an analytical model provided by an embodiment of the present application. As shown in FIG. 5, it includes a graph structure transformation part and an analytical model part. The graph structure transformation part is to transform the CAD model input into the network architecture into a graph structure after a graph reconstruction.

In some examples, for a CAD model represented by a graph structure, a half-edge data structure can be adopted to specify a node of the graph structure. The node of the graph structure includes a bounded face, an edge and a coedge. Then, according to the topological structure (or topological information) of the CAD model and directionality of the half-edge data structure, a connection relationship (or an association matrix, an adjacency matrix) between the nodes can be determined. The half-edge data structure means that information of an edge of a grid is not stored in this structure, but rather a half-edge, where the half-edge is actually half of an edge, which is equivalent to that the length of an edge keeps unchanged, and the edge is formally divided into two half-edges, and the two half-edges are combined to form an edge, that is, an edge is equal to a pair of half-edges. In addition, a half-edge has a direction, and a pair of half-edges of an edge have opposite directions.

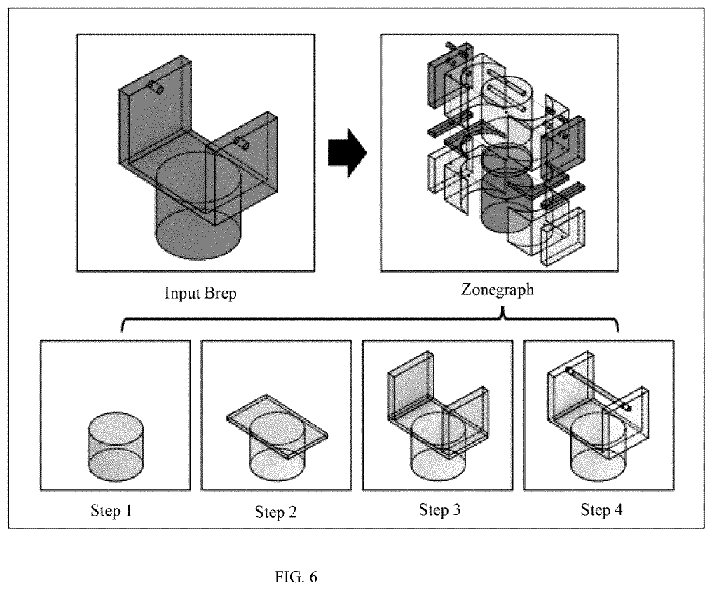

In another implementation, a zonegraph method describes a CAD model in the form of graph structure. FIG. 6 is a schematic diagram of the zonegraph method provided by an embodiment of the present application. As shown in FIG. 6, the zonegraph method describes a modeling process of the CAD model as how to search a zone with a body in the current zonegraph, where a single zone is configured for identifying an extrusion feature and the combination of zones is configured for identifying a Boolean operation. Since the search is carried out in the zonegraph space, the search order can be sorted by the graph neural network (GNN), and a desired geometric model can be generated after extrusion and recognition in turn.

However, since the determination and recognition of the zonegraph method is based on the extrusion feature, it lacks expansibility and cannot be used to identify other features. Moreover, the iterative output of this method is the geometric structure and Boolean operation of each intermediate state, which is only suitable for demonstrating the building process of the CAD model and difficult for subsequent parametric editing.
S403: inputting the graph structure into the analytical model to obtain a modeling sequence of the CAD model output by the analytical model, where the modeling sequence represents a feature modeling-based model building process, and the modeling sequence contains a modeling feature type and a feature parameter corresponding to the modeling feature type. The analytical model includes an encoder and a decoder, where the encoder includes a feature extraction module and a pooling module, the feature extraction module is configured for extracting a local feature of a node in the graph structure, and the pooling module is configured for performing a pooling operation on the local feature to output a global feature; the decoder includes a feature fusion module, an inter-attention module and a prediction module, where the feature fusion module is configured for fusing the global feature and a dynamic modeling sequence to output a first fused feature, the inter-attention module is configured for fusing the first fused feature and the local feature to output a second fused feature, the prediction module is configured for outputting a modeling sequence according to the second fused feature, and the dynamic modeling sequence is a dynamic output of the decoder.

The modeling feature type included in the modeling sequence includes a basic modeling feature such as a sketch feature, a reference face feature, an extrusion feature, an extrusion cut feature, a rotation feature, a revolution cut feature, a chamfer feature and a rounded feature. Each modeling feature type also has its corresponding feature parameter, such as a point, a line, an arc, a sweep angle, a center and a radius of a circle, etc.

Still taking FIG. 5 as an example, the sign (<SOS>) that indicates the analytical model starts to analyze and the graph structure obtained based on the above embodiment are input into the analytical model together, an analysis of the CAD model is done until the analytical model outputs a sign (<EOS>) that indicates to stop analyzing, and the modeling sequence corresponding to the CAD model based on a BRep representation can be obtained, that is, the feature modeling-based model building process can be obtained.

Specifically, based on the connection relationship obtained in the above embodiment, the node feature of the node can be extracted by the feature extraction module in the analytical model, that is, the graph reconstruction unit. The node feature includes a bounded face feature, an edge feature and a coedge feature. The node features are fused, for example, through association information between the nodes in the connection relationship, the edge feature and the coedge feature are fused into the bounded face feature, and a fused local feature or high-dimension feature Zₗ can be obtained.

For example, the BrepNet network can also be adopted to extract the node feature of the graph as the high-dimension feature Zₗ of each node.

Further, the global feature or the overall feature Z_{g} of the CAD model can be obtained based on the high-dimension feature Zₗ through the pooling module in the analytical model, that is, the pooling operation, so as to complete the operation of the encoder part of the analytical model. The pooling operation includes a maximum pooling operation and an average pooling operation. Experiments show that the average pooling operation gets better results than the maximum pooling operation.

On the basis of the above embodiment, the overall feature Z_{g} and the dynamic modeling sequence are input to the decoder part, and the dynamic modeling sequence at this time is empty. After passing through the feature fusion module, the inter-attention module and the prediction module of the decoder, a first dynamic output (token) is obtained that can be used as a modeling command C₁ and be input to the decoder together with the overall feature Z_{g} to obtain a second dynamic output that can be used as the modeling command C₂, and the dynamic modeling sequence S=(C₁, C₂, . . . Cᵢ, . . . ) can be obtained by solving it in turn, until the analytical model outputs a sign to stop analyzing, and the analysis is completed, so as to obtain the modeling sequence S=(C₁, C₂, . . . , Cₙ) corresponding to the CAD model.

The feature fusion module includes a fusion module, a masked multi-head self-attention (Masked MSA) module and an Add and Layer Norm (Add&LN) module, which are configured for fusing the global feature and the dynamic modeling sequence to output the first fused feature. The fusion module includes cascading (Concat), fully connected layer (Linear) and activation function layer (Relu).

In addition, the feature fusion module can be specifically configured for: embedding the modeling feature type, the feature parameter and the modeling command position in the dynamic modeling sequence to obtain an intermediate feature sequence; and fusing the global feature and the intermediate feature sequence to output the first fused feature.

Since the decoder part adopts the network architecture of Transformer to analyze the CAD model, it is necessary to embed the dynamic modeling sequence before inputting it into the decoder to enable the high-dimension representation of the dynamic modeling sequence. In an implementation, the embedding manner adopted can be embedding the modeling feature type, the feature parameter and the modeling command position of the dynamic modeling sequence respectively, and the vectors of the obtained modeling feature type, the feature parameter and the modeling command position can be represented by e_{cmd}, eₚₐᵣₐₘ and eᵢₙₓ.

The inter-attention module includes cross multi-head self-attention (Cross MSA), and Add&LN, FeedForward, and Add&LN, which are configured for fusing the first fused feature and the local feature to obtain the second fused feature.

The prediction module includes two linear classifiers, which can be configured for predicting the modeling feature type and the feature parameter according to the second fusion feature to obtain the modeling sequence. The linear classifier includes a fully connected layer and a normalized exponential function (Softmax).

Based on the above embodiments, it can be seen that an analytical model is a kind of deep learning network framework, and the feature of the CAD model are fused by adopting attention mechanism, so that the modeling feature of the CAD model can be better learned.

In some embodiments, there may be several dashed box parts in FIG. 5, which are connected in series for feature fusion. In practical application, the number of the dashed box parts can be set according to the actual situation, so as to get a better model building process of a CAD model.

According to the CAD model analysis method provided by the embodiment of the present application, a connection relationship between nodes in the graph structure can be obtained by transforming a CAD model with a BRep representation into a graph structure, and a modeling sequence is obtained by an analytical model learning a modeling feature in the graph structure according to the connection relationship, where the modeling sequence includes a modeling feature type and a feature parameter, so as to achieve that a feature modeling-based model building process for building the CAD model is deduced based on the CAD model based on a given BRep representation, and facilitate subsequent parametric re-editing of the CAD model.

In some examples, the modeling sequence may include at least one modeling command that includes a modeling feature type and a feature parameter corresponding to the modeling feature type, and the modeling sequence is obtained by stacking feature parameters corresponding to different modeling feature types in the at least one modeling command, where a useless feature parameter in the modeling command is set with a useless identifier.

For example, if the dynamic modeling sequence is S=(C₁, C₂, . . . Cᵢ, . . . ), where Ci=(tᵢ, pᵢ), it represents a modeling command, and the modeling command includes a modeling feature type tᵢ and a feature parameter pᵢ corresponding to the modeling feature type tᵢ. Since each modeling command has a different number of feature parameters, in order to simplify the operation, the feature parameters pᵢ of all modeling feature types tᵢ can be stacked together to construct a vector representation modeling command with the same dimension, for example, construct a 19-dimension vector representation modeling command, that is, Cᵢ∈R^{19×1}. For each modeling command, the useless feature parameter pᵢ can be set with a useless identifier, for example, set as −1. In addition, the useful feature parameter pᵢ, according to the actual situation, may have specific corresponding feature parameter value, which is no restricted here.

In one implementation, the analytical model in the CAD model analysis method can be trained by the followings: acquiring a CAD model data set, where the CAD model data set includes a sample CAD model and a parametric modeling sequence corresponding to the sample CAD model, the parametric modeling sequence is obtained by parameterizing the modeling sequence corresponding to the sample CAD model, and the parametric modeling sequence records the modeling feature type and the feature parameter corresponding to the modeling feature type of the sample CAD model according to the order of building the sample CAD model; transforming the sample CAD model into a graph structure; training the analytical model according to the graph structure and the parametric modeling sequence corresponding to the sample CAD model, to obtain the prediction modeling sequence corresponding to the sample CAD model; determining, based on the cross entropy loss function, a loss value of the prediction modeling sequence relative to the parametric modeling sequence; adjusting the model parameter of the analytical model according to the loss value. A network architecture of a specific analytical model can refer to FIG. 5 in the above embodiment. The difference from the application stage of the analytical model is that in the training stage, the dynamic modeling sequence S=(C₁, C₂, . . . , C₃₂) of the sample CAD model, that is, the parametric modeling sequence, can be obtained as a reference value of the prediction modeling sequence obtained by the analysis of the analytical model.

In practice, since there are few available CAD model data sets, the related CAD model can be downloaded online or from a free community, etc. through the network based on some source files (such as SolidWorks source files), and the modeling sequence is analyzed by writing plug-ins corresponding to the source file, and the model building process of the CAD model is customized, which can be saved as a data exchange format, such as a lightweight object representation (JavaScript Object Notation, Json) format.

FIG. 7 is a schematic diagram of some sample CAD models provided by an embodiment of the present application. As can be seen in FIG. 7, the CAD model data set provided by the present application contains various CAD model samples and has more modeling feature types, where more basic modeling features, such as an extrusion feature, a chamfer feature, a rotation feature, etc., can be learned when the analytical model is trained, which is beneficial to supporting the CAD model analysis method provided by the present application for multi-feature recognition and improving the universality of the method provided by the present application.

Further, in order to enlarge the CAD model data set to include more CAD model samples and basic modeling features, the CAD model data set can also be obtained by the followings: acquiring an initial data set, where the initial data set contains a sample CAD model and a parametric modeling sequence corresponding to the sample CAD model, and the sample CAD model contains a plurality of basic modeling features; and performing data enlargement on the initial data set by a preset data enhancement mode to obtain the CAD model data set, where the data enhancement mode is to adjust a modeling sequence in a back-to-front manner after representing the modeling sequence the model building process of the sample CAD model as the modeling sequence, and the adjustment comprises random deletion and/or random modification.

For example, the initial data set can be obtained by downloading about 10,000 CAD models online or from a free community, ect. and analyzing them. In order to support the training and learning of the analytical model, the initial data set can be enlarged by the data enhancement mode to obtain the CAD model data set. Specifically, the model building process of the CAD model in the initial data set can be firstly represented as a modeling sequence, and the modeling sequence can be transformed into a parametric modeling sequence that records the modeling feature type of the sample CAD model and the feature parameter corresponding to the modeling feature type according to the order of building the sample CAD model. Therefore, the model building process of the CAD model has strong constraints, that is, when building the CAD model, the model building result of the following step depends on the model building result of the previous step. If there is an error in the model building result of the previous step, it will lead to an error in the model building of the following step and make the obtained model building process invalid. In an implementation, the initial data set can be enlarged in a back-to-front manner, for example, by deleting or randomly modifying the feature parameter in the last model building step and the like, so as to reduce the influence of the model building results in the previous step on the model building results in the later step during a model building process.

In addition, in order to ensure the validity of the obtained sample CAD model after being enlarged, the geometric validity of the sample CAD model can also be verified.

In some examples, after data enhancement of the obtained 10,000 sample CAD models, the Python framework (such as PythonOCC API) can be used to verify the geometric validity of the sample CAD model, thus the enhanced CAD model that is invalid is filtered out, and finally about 40,000 CAD models are built.

Based on the obtained CAD model data set after being enlarged, the modeling feature type and the modeling sequence length of the sample CAD model in the CAD model data set can also be statistically analyzed, as shown in Table 1 and Table 2 respectively.

TABLE 1

| | | Reference | | Extrusion | | Revolution | | |
|---|---|---|---|---|---|---|---|---|
| Feature | Sketch | face | Extrusion | cut | Rotating | cut | Fillet | Chamfer |
| proportion | 40% | 11% | 11% | 10% | 8% | 5% | 5% | 2% |

According to the statistical result of the modeling feature type in Table 1, the CAD model data set obtained in the present application mainly includes eight basic modeling features, namely a sketch feature, a reference face feature, an extrusion feature, an extrusion cut feature, a rotation feature, a revolution cut feature, a chamfer feature and a fillet feature, accounting for 40%, 11%, 11%, 10%, 8%, 5% and 5% respectively. Understandably, more modeling feature types can be included with the increasing number of the CAD models.

TABLE 2

| | Modeling sequence length | | | | |
|---|---|---|---|---|---|
| | 0-5 | 5-10 | 10-15 | 15-20 | 20+ |
| Proportion | 64% | 23% | 5% | 3% | 5% |

It should be noted that although the sketch in the CAD model data set contain many two-dimensional line segments, for example, in case that the two-dimensional sketch is a quadrangle, it takes four steps to draw, and in case that the two-dimensional sketch is a triangle, it takes three steps to draw, but the statistics are made according to a length unit.

For example, the sample CAD model contained in the obtained CAD model data set may be a three-dimensional model based on a BRep representation. In addition, the CAD model data set also includes a feature representation-based modeling sequence corresponding to the CAD model, and the modeling sequence represents the feature modeling-based model building process.

Further, in order to represent the model building process as a network, that is, an analytical model and an identifiable data structure, the model building process can be represented as a dynamic modeling sequence with parameters, that is, a parametric modeling sequence, the dynamic modeling sequence records the model building process according to the model building order and contains the modeling feature type and the feature parameter corresponding to the modeling feature type. Since the modeling feature types contained in the dynamic modeling sequence are discrete, and the feature parameters corresponding to the modeling feature types are continuous parameters, in order to simplify training of the analytical model, the feature parameters can be discretized. A specific discretization setting is shown in Table 3, including a modeling command, a feature parameter and corresponding description.

TABLE 3

| Modeling | Feature | |
|---|---|---|
| command | parameter | Description |
| <SOS> | Ø | a sign of the beginning of a sequence |
| L | x, y | line end point |
| A | x, y | arc end point |
| | α | sweep angle |
| | f | clockwise flag |
| C | x, y | circle center point |
| | r | circle radius |
| E | tx, ty, tz | sketch plane transformation |
| | θ, γ, δ | sketch plane rotation |
| | s | scale of the sketch |
| | e1, e2 | extrude distance for both direction |
| Ec | =E | |
| Ax | tx, ty, tz | sketch plane transformation |
| | θ, γ, δ | sketch plane rotation |
| R | tx, ty, tz | sketch plane transformation |
| | θ, γ, δ | sketch plane rotation |
| | s | scale of the sketch |
| | α | revolution angle |
| Rc | =R | |
| F | px, py, pz | 3D point in the filleted edge |
| Cf | =F | 3D point in the chamfered edge |
| <PAD> | Ø | representation of a complete character |
| <EOS> | Ø | sign of end of sequence |

The modeling command L represents a line, A represents an arc, C represents a circle, E represents an extrusion, Ec represents an extrusion cut, Ax represents a revolution axis, R represents a revolution, Rc represents a revolution cut, F represents a fillet, and CF represents a chamfer.

For example, during the training process of analytical model, the feature parameters pᵢ of all modeling feature types tᵢ in the input dynamic modeling sequence S=(C₁, C₂, . . . Cᵢ, . . . Cₙ) can also be stacked to simplify the operation. For details, please refer to the above-mentioned embodiment, which is not repeated here.

In addition, a maximum length of the dynamic modeling sequence can be preset to improve the parallelism of analytical model. For example, if the maximum length of dynamic modeling sequence is set to 32, the dynamic modeling sequence S=(C₁, C₂, . . . , C₃₂). Specifically, the maximum length of modeling sequence can be set according to the actual situation, which is not limited here.

In some embodiments, the discretization (or quantification) of the feature parameter can simplify training of the analytical model, improve analytical efficiency of the analytical model and shorten the deducing time. For example, in the quantification stage of the feature parameter, the CAD model can be scaled to a cube with a size of 2×2×2, and then the feature parameter can be quantized according to 256 levels, that is, the range of values of edges of the cube can be set to [−1,1], and the [−1,1] can be divided into 256 intervals and then quantized to obtain the quantization result (or discretization result) of the feature parameter.

Based on the above embodiment, after the construction of the CAD model data set and the parameterized (or digitized) representation of the dynamic modeling sequence are completed, during the training of the analytical model provided by the present application, the feature parameter can be discretized in order to simplify the training of analytical model; the feature parameters pᵢ of all modeling feature types tᵢ in the input dynamic modeling sequence S=(C₁, C₂, . . . Cᵢ, . . . Cₙ) can be stacked in order to simplify operations; in order to maximize the probability of the prediction modeling sequence output by the analytical model, it may further include: maximizing the probability of the prediction modeling sequence by using a joint probability distribution function that maximizes the feature type and maximizes the feature parameter, where the joint probability distribution function satisfies the following formula:

$$p ( S ; θ ) = {\prod }_{i = 1}^{N} p ( {t}_{i} , {p}_{i} \vert {t}_{< i} , {p}_{< i} , z ; θ )$$

where p (S; θ) represents the joint probability distribution function of the maximized feature type and the maximized feature parameter, S represents the prediction modeling sequence, θ represents the model parameter of the analytical model, N represents a length of dynamic modeling sequence, z represents the modeling feature of the CAD model, t represents the modeling feature type, p represents the feature parameter, tᵢ and pᵢ respectively represents the modeling feature type and the feature parameter output by the analytical model at a moment i, and t_{<i} and p_{<i} respectively represents the modeling feature type and the feature parameter output by the analytical model at a moment i−1.

In addition, based on the cross entropy loss function, a loss value can be calculated for the prediction modeling sequence with the maximum probability predicted by the analytical model and the parametric modeling sequence; according to the loss value, the model parameter of the analytical model are adjusted, and the training of the analytical model is completed when the loss value converges.

Further, based on the obtained prediction modeling sequence, the prediction modeling feature type contained in the prediction modeling sequence and the prediction feature parameter corresponding to the prediction modeling feature type can be parametric re-edited, that is, the parameter value of the prediction feature parameter can be modified, so that the CAD model built based on the prediction modeling feature type and the prediction feature parameter is more similar to the sample CAD model.

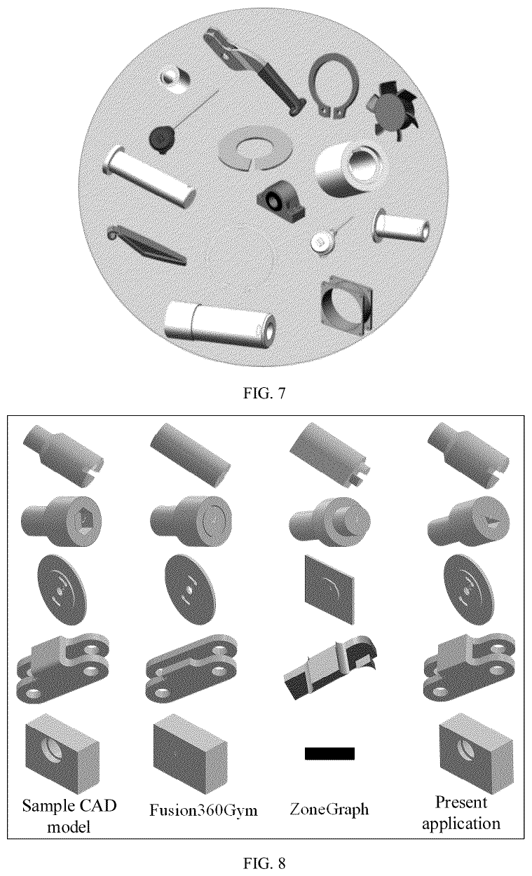

In some embodiments, the advantages of the method provided in the present application can be illustrated qualitatively and quantitatively. First of all, in the quantitative aspect, the geometric difference between the CAD model generated by the predicted or deduced model building process and the input CAD model is evaluated mainly by the three-dimensional intersection of union (IOU); the proportion of effective modeling sequence generated by the algorithm is evaluated by recall; the efficiency of the algorithm is evaluated by runtime and the unit is second(s). Specifically, the method provided in the present application is compared with Fusion360Gym and zoneGraph, and a quantitative comparison result is shown in Table 4 and the qualitative comparison result is shown in FIG. 8.

TABLE 4

| Method | IOU | Recall | Runtime(s) |
|---|---|---|---|
| Fusion360Gym | 0.85 | 0.82 | 20 |
| ZoneGraph | 0.90 | 0.5 | 38.5 |
| Present application | 0.90 | 0.8 | 3.9 |

From the quantitative comparison result in Table 4, it can be seen that the method provided in the present application can achieve better intersection of union, and the modeling efficiency of the algorithm is obviously higher than that of the other two methods.

As can be seen from the qualitative comparison result in FIG. 8, compared with the modeling results of the other two methods, the modeling results of the method provided by the present application are more similar to the reference CAD model, and the modeling accuracy is also higher.

To sum up, the present application has at least the following advantages:
1. The modeling feature type and the feature parameter output by the analytical model can enable parametric editing and modification of the built CAD model.
2. The analytical model provided is a prediction framework of the modeling sequence based on Transformer, which can deduce the corresponding modeling feature and model building process according to the input geometric structure based on the BRep, and has general universality.
3. A CAD model data set with various modeling features is built to train the analytical model, which can support multi-feature recognition, such as an extrusion feature, a chamfer feature and a rotation feature, etc., compared with the algorithm that only recognizes an extrusion feature.
4. When using the neural network, that is, analytical model, to deduce and predict the model building process of the CAD model, discretizing the feature parameters can simplify training of the analytical model, reduce complexity and improve processing efficiency.
5. The feature parameters corresponding to all modeling feature types in the input dynamic modeling sequence are stacked, which can simplify the training operation of the analytical model.

The following is the apparatus embodiment of the present application, which can be configured for executing the method embodiment of the present application. For details not disclosed in the apparatus embodiment of the present application, please refer to the method embodiment of the present application.

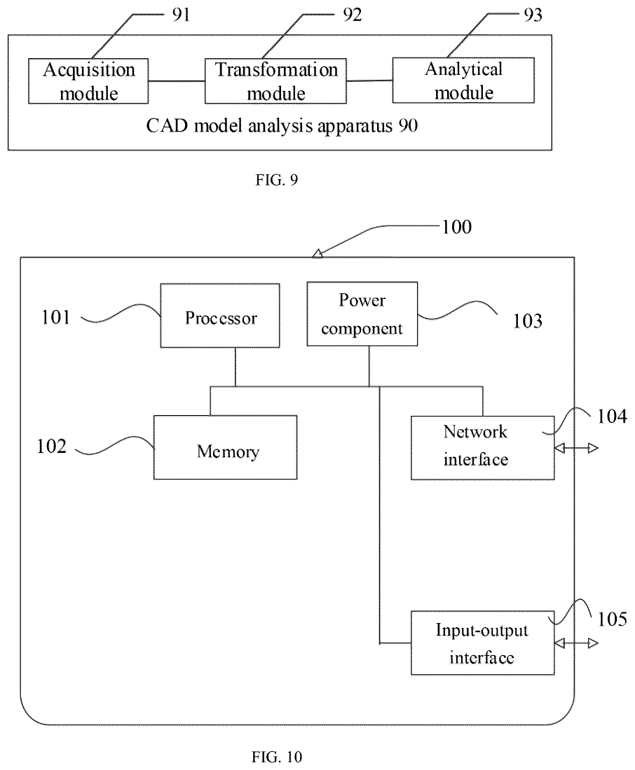

FIG. 9 is a schematic structural diagram of a CAD model analysis apparatus provided by an embodiment of the present application. For convenience of explanation, only the parts related to the embodiment of the present application are shown. As shown in FIG. 9, the CAD model analysis apparatus 90 includes an acquisition module 91, a transformation module 92 and an analytical module 93, where
the acquisition module 91 is configured to acquire a CAD model based on a BRep representation;
the transformation module 92 is configured to transform the CAD model into a graph structure, and a node of the graph structure contains a bounded face, an edge and a coedge, and the edge of the graph structure represents a connection relationship between nodes in the graph structure, and the connection relationship is determined according to a topological structure of the CAD model and directionality of the graph structure; and
the analytical module 93 is configured to input the graph structure into an analytical model to obtain a modeling sequence of the CAD model output by the analytical model, where the modeling sequence represents a feature modeling-based model building process, and the modeling sequence contains a modeling feature type and a feature parameter corresponding to the modeling feature type. The analytical model includes an encoder and a decoder, the encoder includes a feature extraction module and a pooling module, the feature extraction module is configured for extracting a local feature of the node in the graph structure, and the pooling module is configured for performing a pooling operation on the local feature to output a global feature; the decoder includes a feature fusion module, an inter-attention module and a prediction module, the feature fusion module is configured for fusing the global feature and a dynamic modeling sequence to output a first fused feature, and the inter-attention module is configured for fusing the first fused feature and the local feature to output a second fused feature, and the prediction module is configured for outputting the modeling sequence according to the second fused feature, and the dynamic modeling sequence is a dynamic output of the decoder.

In a possible implementation, the analytical module 93 can be specifically configured to obtain the modeling sequence, where the obtained modeling sequence contains at least one modeling command, the modeling command contains a modeling feature type and a feature parameter corresponding to the modeling feature type, the modeling sequence is obtained by stacking feature parameters corresponding to different modeling feature types in the at least one modeling command, and a useless feature parameter in the modeling command is set with a useless identifier.

In a possible implementation, the feature fusion module in the CAD model analysis apparatus can be specifically configured for: embedding for a modeling feature type, a feature parameter and a modeling command position in the dynamic modeling sequence to obtain an intermediate feature sequence; and fusing the global feature and the intermediate feature sequence to output the first fused feature.

In a possible implementation, the analytical model in the CAD model analysis apparatus can be trained by the following: the acquisition module 91 can be specifically configured for acquiring a CAD model data set that includes a sample CAD model and a parametric modeling sequence corresponding to the sample CAD model, and the parametric modeling sequence is obtained by parameterizing a modeling sequence corresponding to the sample CAD model, and the parametric modeling sequence records the modeling feature type and the feature parameter corresponding to the modeling feature type of the sample CAD model according to an order of building the sample CAD model; correspondingly, the transformation module 92 can be specifically configured for transforming the sample CAD model into a graph structure; and the analytical module 93 can also be configured for training the analytical model according to the graph structure corresponding to the sample CAD model and the parametric modeling sequence to obtain a prediction modeling sequence corresponding to the sample CAD model. Correspondingly, the CAD model analysis apparatus can also include a determining module (not shown) and an adjusting module (not shown), where the determining module can be specifically configured for determining, based on a cross entropy loss function, a loss value of the prediction modeling sequence relative to the parametric modeling sequence; and the adjustment module can be specifically configured for adjusting a model parameter of the analytical model according to the loss value.

In a possible implementation, the CAD model analysis apparatus may further include a maximization module (not shown) that may be specifically configured for adopting a joint probability distribution function of a maximized feature type and a maximized feature parameter to maximize a probability of the prediction modeling sequence, where the joint probability distribution function satisfies the following formula:

$$p ( S ; θ ) = {\prod }_{i = 1}^{N} p ( {t}_{i} , {p}_{i} \vert {t}_{< i} , {p}_{< i} , z ; θ )$$

where p(S; θ) represents the joint probability distribution function of the maximized feature type and the maximized feature parameter, S represents the prediction modeling sequence, θ represents the model parameter of the analytical model, N represents a length of dynamic modeling sequence, z represents the modeling feature of the CAD model, t represents the modeling feature type, p represents the feature parameter, tᵢ and pᵢ respectively represents the modeling feature type and the feature parameter output by the analytical model at a moment i, and t_{<i} and p_{<i} respectively represents the modeling feature type and the feature parameter output by the analytical model at a moment i−1.

In a possible implementation, the CAD model data set in the CAD model analysis apparatus is obtained by the followings: the acquisition module 91 can also be configured for acquiring an initial data set that contains a sample CAD model and a parametric modeling sequence corresponding to the sample CAD model, and the sample CAD model contains a plurality of basic modeling features; correspondingly, the CAD model analysis apparatus can also include a data enlargement module (not shown) that can be specifically configured for performing data enlargement on the initial data set through a preset data enhancement mode as to obtain a CAD model data set, where the data enhancement mode is to adjust a modeling sequence in a back-to-front manner after representing the modeling sequence the model building process of the sample CAD model as the modeling sequence, and the adjustment includes random deletion and/or random modification.

In a possible implementation, the sample CAD model in the CAD model analysis apparatus has geometric validity.

The implementation principle and technical effect of the CAD model analysis apparatus provided by the embodiment of the present application are similar to those of the above-mentioned embodiment. For details, please refer to the above-mentioned embodiment, which is not repeated here.

FIG. 10 is a schematic structural diagram of an electronic device provided by an embodiment of the present application. For example, the electronic device may be provided as a server. As shown in FIG. 10, the electronic device 100 includes:
a processor 101, which further includes one or more processors, and a memory resource represented by a memory 102, for storing an instruction executable by the processor 101, such as an application program. The application program stored in the memory 102 may include one or more modules each corresponding to a set of processing instructions. Furthermore, the processor 101 is configured for executing an instruction to execute the CAD model analysis method described above.

The electronic device 100 may further include a power component 103 configured for performing power management of the electronic device 100, a wired or wireless network interface 104 configured for connecting the electronic device 100 to a network, and an input-output interface 105. The electronic device 100 can operate based on an operating system stored in the memory 102, such as X86, Windows Server™, Mac OS X™, Unix™, Linux™, FreeBSD™ or the like.

The processor included in the processor 101 mentioned in FIG. 10 may be a general-purpose processor, including a central processing unit, a network processor (NP), etc. a digital signal processor (DSP), an application specific integrated circuit (ASIC), a field programmable gate array (FPGA) or another programmable logic equipment, a discrete gate or transistor logic equipment or a discrete hardware component.

The memory 102 may include a random access memory (RAM) or a static random access memory (SRAM), an electric erasable programmable read-only memory (EEPROM), an erasable programmable read-only memory (EPROM), a programmable read-only memory (PROM), a read-only memory (ROM), a magnetic memory, a flash memory, a magnetic disk or an optical disk, such as at least one disk memory.

It can be understood by those skilled in the art that the electronic device shown in FIG. 10 does not constitute a limitation on an electronic device, and may include more or less components than shown, or combine some components, or have a different component arrangement.

The embodiment of the present application also provides a computer-readable storage medium, where the computer-readable storage medium stores a computer-executable instruction that, when executed, enables to implement the above CAD model analysis method.

The embodiment of the present application also provides a computer program product, including a computer program that, when executed, enables to implement the above CAD model analysis method.

The embodiment of the present application also provides a chip for running an instruction, and the chip is configured for executing the CAD model analysis method according to any method embodiment.

It should be noted that the user information (including but not limited to user device information, user personal information, etc.) and data (including but not limited to data for analyzing, data for storing, data for displaying, etc.) involved in the present application are all information and data authorized by an user or fully authorized by all parties, and the collection, use and processing of relevant data need to comply with a relevant law, regulation and standard of a relevant country and region, and a corresponding operation entrance is provided for the user to choose for authorization or rejection.

Other embodiments of the present application will easily occur to those skilled in the art after considering the specification and practicing the invention disclosed herein. The present application is intended to cover any variation, use or adaptation of the present application, which follow the general principle of the present application and include common sense or common technical mean in this technical field that are not disclosed in the present application. The specification and embodiment are to be regarded as exemplary only, with the true scope and spirit of the present application being indicated by the appended claims.

It should be understood that the present application is not limited to the precise structure described above and shown in the drawings, and various modifications and changes can be made without departing from the scope thereof. The scope of the present application is limited only by the appended claims.

What is claimed is:

1. A CAD model analysis method, comprising:
acquiring a CAD model based on a BRep representation;
transforming the CAD model into a graph structure, wherein a node of the graph structure contains a bounded face, an edge and a coedge, the edge of the graph structure represents a connection relationship between nodes in the graph structure, and the connection relationship is determined according to a topological structure of the CAD model and directionality of the graph structure; and
inputting the graph structure into an analytical model to obtain a modeling sequence of the CAD model output by the analytical model, wherein the modeling sequence represents a feature modeling-based model building process, and the modeling sequence contains a modeling feature type and a feature parameter corresponding to the modeling feature type;
wherein the analytical model comprises an encoder and a decoder, the encoder comprises a feature extraction module and a pooling module, the feature extraction module is configured for extracting a local feature of the node in the graph structure, and the pooling module is configured for performing a pooling operation on the local feature to output a global feature;
the decoder comprises a feature fusion module, an inter-attention module and a prediction module, the feature fusion module is configured for fusing the global feature and a dynamic modeling sequence to output a first fused feature, the inter-attention module is configured for fusing the first fused feature and the local feature to output a second fused feature, the prediction module is configured for outputting the modeling sequence according to the second fused feature, and the dynamic modeling sequence is a dynamic output of the decoder.

2. The CAD model analysis method according to claim 1, wherein the modeling sequence contains at least one modeling command, the modeling command contains a modeling feature type and a feature parameter corresponding to the modeling feature type, the modeling sequence is obtained by stacking feature parameters corresponding to different modeling feature types in the at least one modeling command, and a useless feature parameter in the modeling command is set with a useless identifier.

3. The CAD model analysis method according to claim 2, wherein the feature fusion module is specifically configured for:
embedding a modeling feature type, a feature parameter and a modeling command position in the dynamic modeling sequence to obtain an intermediate feature sequence; and
fusing the global feature and the intermediate feature sequence to output the first fused feature.

4. The CAD model analysis method according to claim 1, wherein the analytical model is trained by the followings:
acquiring a CAD model data set, wherein the CAD model data set comprises a sample CAD model and a parametric modeling sequence corresponding to the sample CAD model, the parametric modeling sequence is obtained by parameterizing a modeling sequence corresponding to the sample CAD model, and the parametric modeling sequence records a modeling feature type and a feature parameter corresponding to the modeling feature type of the sample CAD model according to an order of building the sample CAD model;
transforming the sample CAD model into a graph structure;
training the analytical model according to the graph structure corresponding to the sample CAD model and the parametric modeling sequence to obtain a prediction modeling sequence corresponding to the sample CAD model;
determining, based on a cross entropy loss function, a loss value of the prediction modeling sequence relative to the parametric modeling sequence; and
adjusting a model parameter of the analytical model according to the loss value.

5. The CAD model analysis method according to claim 2, wherein the analytical model is trained by the followings:
acquiring a CAD model data set, wherein the CAD model data set comprises a sample CAD model and a parametric modeling sequence corresponding to the sample CAD model, the parametric modeling sequence is obtained by parameterizing a modeling sequence corresponding to the sample CAD model, and the parametric modeling sequence records a modeling feature type and a feature parameter corresponding to the modeling feature type of the sample CAD model according to an order of building the sample CAD model;
transforming the sample CAD model into a graph structure;
training the analytical model according to the graph structure corresponding to the sample CAD model and the parametric modeling sequence to obtain a prediction modeling sequence corresponding to the sample CAD model;
determining, based on a cross entropy loss function, a loss value of the prediction modeling sequence relative to the parametric modeling sequence; and
adjusting a model parameter of the analytical model according to the loss value.

6. The CAD model analysis method according to claim 3, wherein the analytical model is trained by the followings:
acquiring a CAD model data set, wherein the CAD model data set comprises a sample CAD model and a parametric modeling sequence corresponding to the sample CAD model, the parametric modeling sequence is obtained by parameterizing a modeling sequence corresponding to the sample CAD model, and the parametric modeling sequence records a modeling feature type and a feature parameter corresponding to the modeling feature type of the sample CAD model according to an order of building the sample CAD model;
transforming the sample CAD model into a graph structure;
training the analytical model according to the graph structure corresponding to the sample CAD model and the parametric modeling sequence to obtain a prediction modeling sequence corresponding to the sample CAD model;
determining, based on a cross entropy loss function, a loss value of the prediction modeling sequence relative to the parametric modeling sequence; and
adjusting a model parameter of the analytical model according to the loss value.

7. The CAD model analysis method according to claim 4, further comprising:
adopting a joint probability distribution function of a maximized feature type and a maximized feature parameter to maximize a probability of the prediction modeling sequence, wherein the joint probability distribution function satisfies the following formula:
$$p ( S ; θ ) = {\prod }_{i = 1}^{N} p ( {t}_{i} , {p}_{i} \vert {t}_{< i} , {p}_{< i} , z ; θ )$$
wherein p (S; θ) represents the joint probability distribution function of the maximized feature type and the maximized feature parameter, S represents the prediction modeling sequence, θ represents the model parameter of the analytical model, N represents a length of dynamic modeling sequence, z represents a modeling feature of the CAD model, t represents a modeling feature type, p represents a feature parameter, tᵢ and pᵢ respectively represents a modeling feature type and a feature parameter output by the analytical model at a moment i, and t_{<i} and p_{<i} respectively represents a modeling feature type and a feature parameter output by the analytical model at a moment i−1.

8. The CAD model analysis method according to claim 4, wherein the CAD model data set is obtained by:
acquiring an initial data set, wherein the initial data set contains a sample CAD model and a parametric modeling sequence corresponding to the sample CAD model in the initial data set, and the sample CAD model in the initial data set contains a plurality of basic modeling features; and
performing data enlargement on the initial data set by a preset data enhancement mode to obtain the CAD model data set, wherein the data enhancement mode is to adjust a modeling sequence in a back-to-front manner after representing the modeling sequence the model building process of the sample CAD model in the initial data set as the modeling sequence, and the adjustment comprises random deletion and/or random modification.

9. The CAD model analysis method according to claim 6, wherein the sample CAD model in the initial data set has geometric validity.

10. An electronic device, comprising: a memory and a processor;
the memory is configured for storing a program instruction;
the processor is configured for calling the program instruction in the memory to perform the following operation:
acquiring a CAD model based on a BRep representation;
transforming the CAD model into a graph structure, wherein a node of the graph structure contains a bounded face, an edge and a coedge, the edge of the graph structure represents a connection relationship between nodes in the graph structure, and the connection relationship is determined according to a topological structure of the CAD model and directionality of the graph structure; and
inputting the graph structure into an analytical model to obtain a modeling sequence of the CAD model output by the analytical model, wherein the modeling sequence represents a feature modeling-based model building process, and the modeling sequence contains a modeling feature type and a feature parameter corresponding to the modeling feature type;
wherein the analytical model comprises an encoder and a decoder, the encoder comprises a feature extraction module and a pooling module, the feature extraction module is configured for extracting a local feature of the node in the graph structure, and the pooling module is configured for performing a pooling operation on the local feature to output a global feature; the decoder comprises a feature fusion module, an inter-attention module and a prediction module, the feature fusion module is configured for fusing the global feature and a dynamic modeling sequence to output a first fused feature, the inter-attention module is configured for fusing the first fused feature and the local feature to output a second fused feature, the prediction module is configured for outputting the modeling sequence according to the second fused feature, and the dynamic modeling sequence is a dynamic output of the decoder.

11. The electronic device according to claim 10, wherein the modeling sequence contains at least one modeling command, the modeling command contains a modeling feature type and a feature parameter corresponding to the modeling feature type, the modeling sequence is obtained by stacking feature parameters corresponding to different modeling feature types in the at least one modeling command, and a useless feature parameter in the modeling command is set with a useless identifier.

12. The electronic device according to claim 11, wherein the feature fusion module is specifically configured for:
embedding a modeling feature type, a feature parameter and a modeling command position in the dynamic modeling sequence to obtain an intermediate feature sequence; and
fusing the global feature and the intermediate feature sequence to output the first fused feature.

13. The electronic device according to claim 10, wherein the analytical model is trained by the followings:
acquiring a CAD model data set, wherein the CAD model data set comprises a sample CAD model and a parametric modeling sequence corresponding to the sample CAD model, the parametric modeling sequence is obtained by parameterizing a modeling sequence corresponding to the sample CAD model, and the parametric modeling sequence records a modeling feature type and a feature parameter corresponding to the modeling feature type of the sample CAD model according to an order of building the sample CAD model;
transforming the sample CAD model into a graph structure;
training the analytical model according to the graph structure corresponding to the sample CAD model and the parametric modeling sequence to obtain a prediction modeling sequence corresponding to the sample CAD model;
determining, based on a cross entropy loss function, a loss value of the prediction modeling sequence relative to the parametric modeling sequence; and
adjusting a model parameter of the analytical model according to the loss value.

14. The electronic device according to claim 11, wherein the analytical model is trained by the followings:
acquiring a CAD model data set, wherein the CAD model data set comprises a sample CAD model and a parametric modeling sequence corresponding to the sample CAD model, the parametric modeling sequence is obtained by parameterizing a modeling sequence corresponding to the sample CAD model, and the parametric modeling sequence records a modeling feature type and a feature parameter corresponding to the modeling feature type of the sample CAD model according to an order of building the sample CAD model;
transforming the sample CAD model into a graph structure;
training the analytical model according to the graph structure corresponding to the sample CAD model and the parametric modeling sequence to obtain a prediction modeling sequence corresponding to the sample CAD model;
determining, based on a cross entropy loss function, a loss value of the prediction modeling sequence relative to the parametric modeling sequence; and
adjusting a model parameter of the analytical model according to the loss value.

15. The electronic device according to claim 12, wherein the analytical model is trained by the followings:
acquiring a CAD model data set, wherein the CAD model data set comprises a sample CAD model and a parametric modeling sequence corresponding to the sample CAD model, the parametric modeling sequence is obtained by parameterizing a modeling sequence corresponding to the sample CAD model, and the parametric modeling sequence records a modeling feature type and a feature parameter corresponding to the modeling feature type of the sample CAD model according to an order of building the sample CAD model;
transforming the sample CAD model into a graph structure;
training the analytical model according to the graph structure corresponding to the sample CAD model and the parametric modeling sequence to obtain a prediction modeling sequence corresponding to the sample CAD model;
determining, based on a cross entropy loss function, a loss value of the prediction modeling sequence relative to the parametric modeling sequence; and
adjusting a model parameter of the analytical model according to the loss value.

16. The electronic device according to claim 13, the processor is configured for calling the program instruction in the memory to further perform the following operation:
adopting a joint probability distribution function of a maximized feature type and a maximized feature parameter to maximize a probability of the prediction modeling sequence, wherein the joint probability distribution function satisfies the following formula:
$$p ( S ; θ ) = {\prod }_{i = 1}^{N} p ( {t}_{i} , {p}_{i} \vert {t}_{< i} , {p}_{< i} , z ; θ )$$
wherein p(S; θ) represents the joint probability distribution function of the maximized feature type and the maximized feature parameter, S represents the prediction modeling sequence, θ represents the model parameter of the analytical model, N represents a length of dynamic modeling sequence, z represents a modeling feature of the CAD model, t represents a modeling feature type, p represents a feature parameter, tᵢ and pᵢ respectively represents a modeling feature type and a feature parameter output by the analytical model at a moment i, and t_{<i} and p_{<i} respectively represents a modeling feature type and a feature parameter output by the analytical model at a moment i−1.

17. The electronic device according to claim 13, wherein the CAD model data set is obtained by:
acquiring an initial data set, wherein the initial data set contains a sample CAD model and a parametric modeling sequence corresponding to the sample CAD model in the initial data set, and the sample CAD model in the initial data set contains a plurality of basic modeling features; and
performing data enlargement on the initial data set by a preset data enhancement mode to obtain the CAD model data set, wherein the data enhancement mode is to adjust a modeling sequence in a back-to-front manner after representing the modeling sequence the model building process of the sample CAD model in the initial data set as the modeling sequence, and the adjustment comprises random deletion and/or random modification.

18. The electronic device according to claim 17, wherein the sample CAD model in the initial data set has geometric validity.

19. A non-transitory computer-readable storage medium, wherein the non-transitory computer-readable storage medium stores a computer-executable instruction that, when executed, enables to perform the following operation:
acquiring a CAD model based on a BRep representation;
transforming the CAD model into a graph structure, wherein a node of the graph structure contains a bounded face, an edge and a coedge, the edge of the graph structure represents a connection relationship between nodes in the graph structure, and the connection relationship is determined according to a topological structure of the CAD model and directionality of the graph structure; and
inputting the graph structure into an analytical model to obtain a modeling sequence of the CAD model output by the analytical model, wherein the modeling sequence represents a feature modeling-based model building process, and the modeling sequence contains a modeling feature type and a feature parameter corresponding to the modeling feature type;
wherein the analytical model comprises an encoder and a decoder, the encoder comprises a feature extraction module and a pooling module, the feature extraction module is configured for extracting a local feature of the node in the graph structure, and the pooling module is configured for performing a pooling operation on the local feature to output a global feature; the decoder comprises a feature fusion module, an inter-attention module and a prediction module, the feature fusion module is configured for fusing the global feature and a dynamic modeling sequence to output a first fused feature, the inter-attention module is configured for fusing the first fused feature and the local feature to output a second fused feature, the prediction module is configured for outputting the modeling sequence according to the second fused feature, and the dynamic modeling sequence is a dynamic output of the decoder.

20. The non-transitory computer-readable storage medium according to claim 19, wherein the modeling sequence contains at least one modeling command, the modeling command contains a modeling feature type and a feature parameter corresponding to the modeling feature type, the modeling sequence is obtained by stacking feature parameters corresponding to different modeling feature types in the at least one modeling command, and a useless feature parameter in the modeling command is set with a useless identifier.
